(19) United States
(12) Patent Application Publication
(10) Pub. No.: US 2022/0197649 A1
(43) Pub. Date: Jun. 23, 2022

(54) GENERAL PURPOSE REGISTER HIERARCHY SYSTEM AND METHOD

(71) Applicant: ADVANCED MICRO DEVICES, INC., Santa Clara, CA (US)

(72) Inventors: Prasanna Balasundaram, San Diego, CA (US); Dipayan Karmakar, San Diego, CA (US); Brian Emberling, Palo Alto, CA (US)

(21) Appl. No.: 17/557,667

(22) Filed: Dec. 21, 2021

Related U.S. Application Data
(60) Provisional application No. 63/129,094, filed on Dec. 22, 2020.

(51) Int. Cl. G06F 9/30; G06F 9/50; G06F 1/3225

(52) U.S. Cl. CPC G06F 9/30141; G06F 1/3225; G06F 9/5016; G06F 9/3004

(57) ABSTRACT

A processing unit includes a first memory device and a second memory device. The first memory device includes a first plurality of general purpose registers (GPRs) and the second memory device includes a second plurality of GPRs. The second memory device includes fewer GPRs than the first memory device. Program data is stored at the first memory device and the second memory device based on expected frequency of accesses associated with the program data.

### BACKGROUND

Many processors include general purpose registers (GPRs) for storing temporary program data during execution of the program. The GPRs are arranged in a memory device, such as a register file, that is generally located within the processor for quick access. Because the GPRs are easily accessed by the processor, it is desirable to use a larger register file. Additionally, some programs request a certain number of GPRs and, in some cases, a system having fewer than the requested number of GPRs affects the system's ability to execute the program in a timely manner or, in some cases, without erroneous operation. Further, in some cases, memory devices that include more GPRs are more area efficient on a per-bit basis, as compared to memory devices that include fewer GPRs. However, power consumption of memory devices as part of read and write operations scales with the number of GPRs. As a result, accessing GPRs in a larger memory device consumes more power as compared to accessing GPRs in a smaller memory device.

### BRIEF DESCRIPTION OF THE DRAWINGS

The present disclosure is better understood, and its numerous features and advantages made apparent to those skilled in the art, by referencing the accompanying drawings. The use of the same reference symbols in different drawings indicates similar or identical items.

FIG. 1 is a block diagram of a processing unit that includes a GPR hierarchy in accordance with some embodiments.

FIG. 2 is a block diagram of a compiler of a processing unit that includes a GPR hierarchy in accordance with some embodiments.

FIG. 3 is a flow diagram of a method of allocating GPRs in accordance with some embodiments.

FIG. 4 is a flow diagram of a method of reallocating GPRs in accordance with some embodiments.

FIG. 5 is a block diagram of a processing system that includes a GPR hierarchy in accordance with some embodiments.

### DETAILED DESCRIPTION

A processing unit includes multiple memory devices that each include different respective numbers of general purpose registers (GPRs). In some embodiments, the GPRs have a same design, and, as a result, accesses to a memory device that includes fewer GPRs consume less power on average, as compared to a memory device that includes more GPRs. Because the processing unit also includes the memory device that includes more GPRs, the processing unit is able to execute programs that request more GPRs than a processing system that only includes the memory device that includes fewer GPRs.

Additionally, in some programs, some program variables are used more frequently than other program variables. In some embodiments, the processing unit identifies program variables that are expected to be frequently accessed. GPRs of the memory device that includes fewer GPRs are allocated to program variables expected to be frequently accessed. In some cases, the memory device that includes fewer GPRs is more frequently accessed, as compared to an allocation scheme where the GPRs are naively allocated. As a result, the processing unit completes programs more quickly and/or using less power, as compared to a processing unit that uses a naive allocation of GPRs. In some embodiments, because programs are executed using less power, the processing unit is designed to include additional components such as additional GPRs without exceeding a power boundary of the processing unit.

The techniques described herein are, in different embodiments, employed using any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like). For ease of illustration, reference is made herein to example systems and methods in which processing modules are employed. However, it will be understood that the systems and techniques described herein apply equally to the use of other types of parallel processors unless otherwise noted.

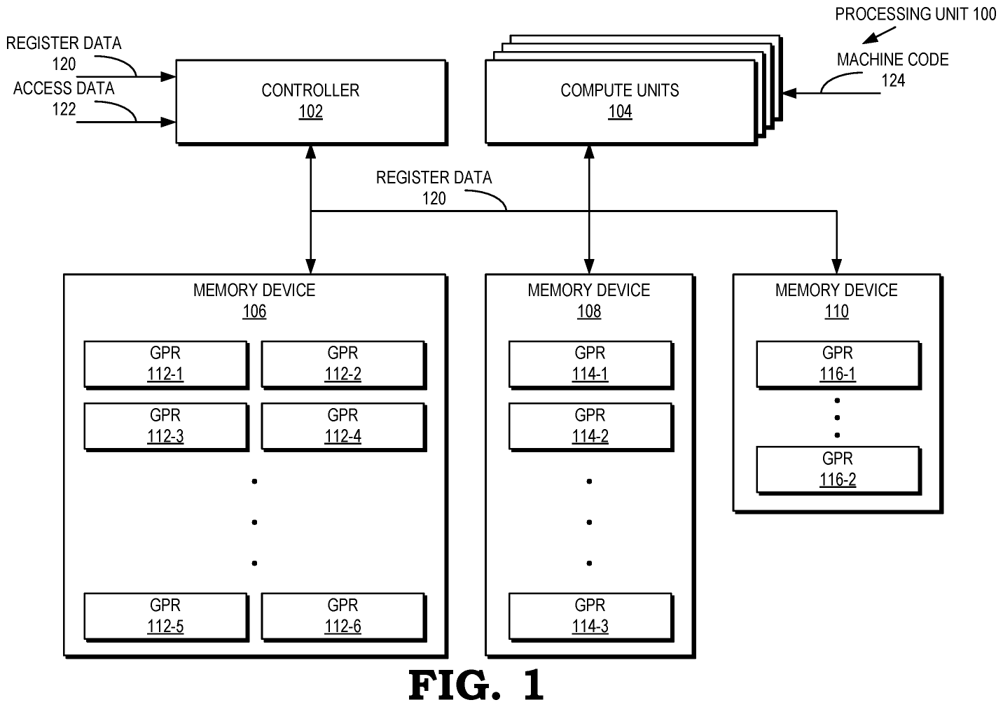

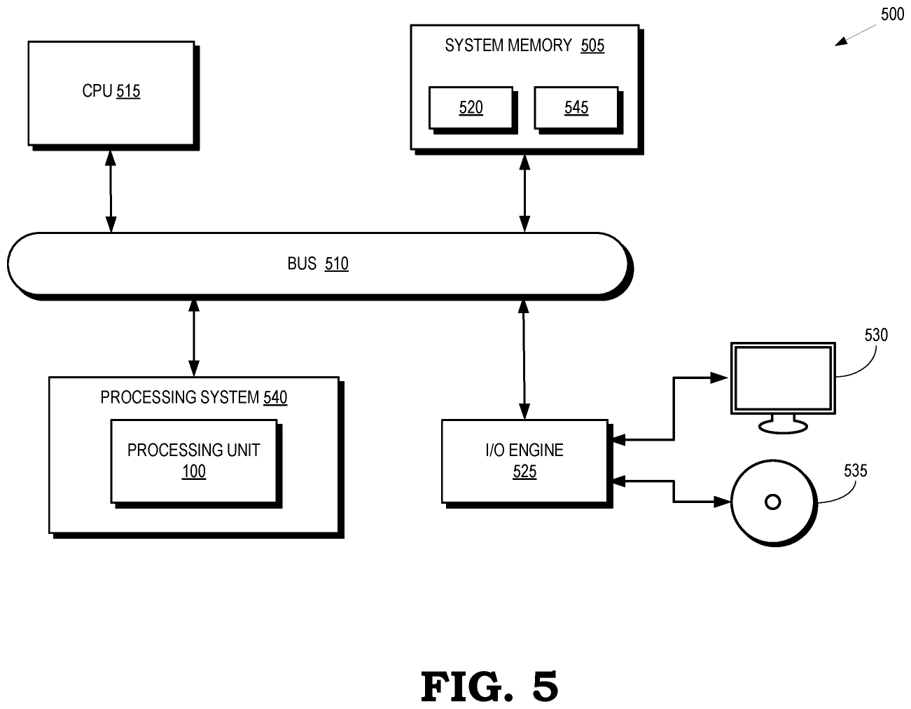

FIG. 1 illustrates a processing unit 100 that includes a GPR hierarchy in accordance with at least some embodiments. Processing unit 100 includes a controller 102, a plurality of compute units 104, a first memory device 106, a second memory device 108, and a third memory device 110. First memory device 106 includes GPRs 112. Second memory device 108 includes GPRs 114. Third memory device 110 includes GPRs 116. In some embodiments, as described below with reference to FIG. 5, processing unit 100 is a shader processing unit of a graphics processing unit. In other embodiments, processing unit 100 is another type of processor. For clarity and ease of explanation, FIG. 1 only includes the components listed above. However, in other embodiments, additional components, such as cache memories, memory devices that do not include GPRs, or additional memory devices that include GPRs are contemplated. Further, in some embodiments, fewer components are contemplated. For example, in some embodiments, processing unit 100 only includes two memory devices that include GPRs, processing unit 100 only includes one compute unit, or both.

Compute units 104 execute programs using machine code 124 of those programs and register data 120 stored at memory devices 106-110. In some cases, multiple compute units 104 executes respective portions of a single program in parallel. In other cases, each compute unit 104 executes a respective program. In some embodiments, compute units 104 are shader engines or arithmetic and logic units (ALUs) of a shader processing unit.

Memory devices 106-110 include respective different numbers of GPRs. In the illustrated example, second memory device 108 includes fewer GPRs than first memory device 106, and third memory device 110 includes fewer GPRs than second memory device 108. However, because GPRs 112-116 share a same design, a read or write operation using GPR 112-4 consumes more power on average than a similar read or write operation using GPR 116-1. More specifically, when a memory device is used as part of a read operation, a certain amount of power is consumed per GPR in the memory device. As a result, when the GPRs share a same design, a read operation using a memory device that includes fewer GPRs consumes less power on average, as compared to a memory device that includes more GPRs. A similar relationship is true during write operations. As a result, as explained further below, register data 120 expected to be used more frequently are stored in GPRs 116 and register data 120 expected to be used less frequently is stored in GPRs 112. Accordingly, memory devices 106-110 are organized in a hierarchy. However, unlike a cache hierarchy, for example, in some embodiments, redundant data is not stored at slower memory devices and memory devices are not accessed in the hope that a GPR stores the requested data. Processing unit 100 tracks where the program data is stored. Further, in some embodiments, GPRs are directly addressed, as compared to caches, which are generally searched to find desired data because of how data moves between levels of a cache hierarchy. In embodiments where the GPRs have different designs, other advantages, such as faster read times or differing heat properties, are leveraged.

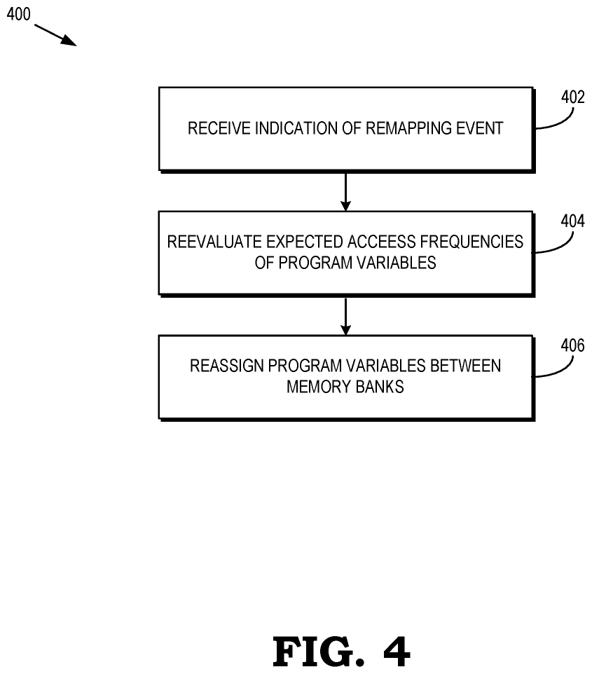

Controller 102 manages data at processing unit 100. Controller 102 receives register data 120, which includes program data (e.g., variables) to be stored at memory devices 106-110 and used by one or more of compute units 104 during execution of the program. Controller 102 additionally receives access data 122, which is indicative of a predicted frequency of access of the respective variables of the program. In some cases, based on the access data 122, controller 102 sends some register data 120 to be stored at memory device 106, some register data 120 to be stored at memory device 108, and some register data 120 to be stored at memory device 110. Memory device 110 receives the register data 120 expected to be accessed the most frequently (e.g., loop variables or multiply-accumulate data) and memory device 106 receives the register data 120 expected to be accessed the least frequently. Additionally, in the illustrated embodiment, during execution of programs, controller 102 reads GPRs 112-116 and cause the register data 120 to be sent between memory devices 106-110 and compute units 104. In some cases, such as in response to a remapping event as described below with reference to FIG. 4, controller 102 retrieves register data 120 from a GPR of one memory device (e.g., GPR 112-2) and stores the register data 120 at a GPR of another memory device (e.g., GPR 114-3) either directly or subsequent to the register data 120 being used by one or more of compute units 104.

In some embodiments, controller 102 determines access data 122. For example, controller 102 determines access data 122 by compiling program data into machine code 124. As another example, controller 102 determines access data 122 based on register requests received from the programs (e.g., a program requests that four variables be stored in memory device 110). As yet another example, controller 102 determines access data 122 based on register rules (e.g., a program-specific rule states that only one GPR from memory device 110 be allocated to a particular program or that a specific variable be allocated a GPR from memory device 108 or a global rule that that no more than three GPRs from memory device 110 be allocated to any one program). In various embodiments, access data 122 includes an indication of a remapping event. In response to an indication of a remapping event, controller 102 changes an assignment of at least one data value from a memory device (e.g., memory device 110) to another memory device (e.g., memory device 106). In some embodiments, controller 102 is controlled by or executes a shader processing shader program.

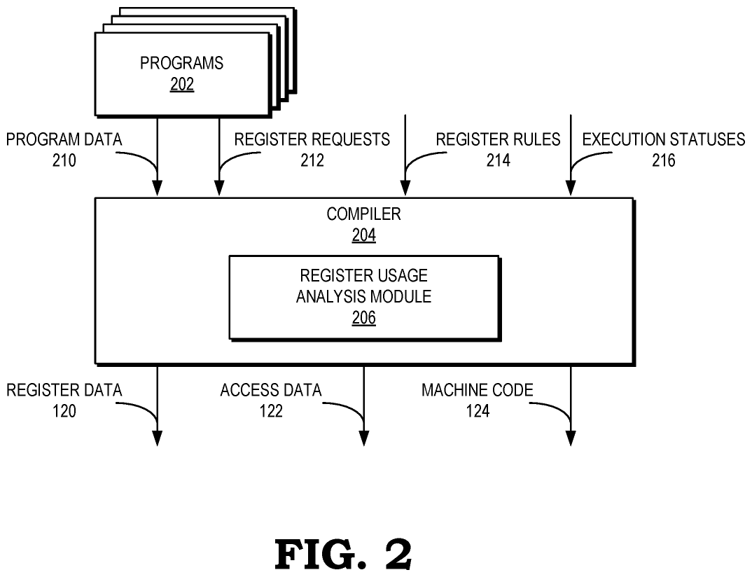

FIG. 2 is a block diagram illustrating programs 202 and a compiler 204 of a processing unit (e.g., processing unit 100 of FIG. 1) that includes a GPR hierarchy in accordance with some embodiments. In the illustrated embodiment, compiler 204 includes register usage analysis module 206. Although the illustrated embodiment shows programs 202, compiler 204, and register usage analysis module 206 as separate from the processing unit, in various embodiments, one or more of programs 202, compiler 204, and register usage analysis module 206 are stored at or run by portions of the processing unit. For example, in some embodiments, compiler 204 or register usage analysis module 206 is executed by a controller (e.g., controller 102) or by one or more of compute units 104. As another example, in some embodiments, one or more od memory devices 106-110 includes additional storage configured to store programs 202.

As described above, register data 120 is stored in memory devices based on an expected frequency of access of the register data 120. Compiler 204 receives program data 210, register requests 212, register rules 214, execution statuses 216, or any combination thereof, and determines the expected frequency of accesses based on the received data using register usage analysis module 206. For example, compiler 204 receives program data 210 from programs 202 and converts program data 210 into machine code 124. Additionally, compiler 204 uses register usage analysis module 206 to analyze program data 210, machine code 124, or both, and determine, based on cost heuristics, expected access frequencies corresponding to variables of the programs. Compiler 204 then compares the expected access frequencies to one or more access frequency thresholds and assigns the variables to memory devices having differing numbers of GPRs. Compiler 204 indicates the variables via register data 120 and the assignments via access data 122. Compiler 204 additionally monitors execution statuses of the programs 202 via execution statuses 216 to prevent compiler 204, in some cases, from over allocating GPRs. Further, in some cases, assigning the variables to the memory devices is based on a number of unassigned GPRs in one or more of the memory devices.

In some embodiments, programs 202 request changes to the allocation of variables to memory devices. For example, a program 202 requests, via a register request 212, that a particular variable be assigned to a particular memory device (e.g., memory device 110). As another example, a program 202 requests, via register requests 212 that a particular number of GPRs of a particular memory device (e.g., memory device 108) be allocated to the program 202.

In some embodiments, other entities (e.g., a user or another device) provide register rules 214 that affect the allocation of variables to memory devices. For example, a user specifies the access frequency threshold used to determine which variables are to be assigned to the memory devices. As another example, register rules 214 include a program-specific rule that no more than a specified number of GPRs of a memory device be assigned to a program indicated by the program-specific rule. As a third example, register rules 214 include a global rule that no more than a specified number of GPRs of a memory device be assigned to any one program. To illustrate, in response to entering a power saving mode, a power management device indicates via a register rule 214 that GPRs of memory device 106 are not to be allocated.

Additionally, as further described below with reference to FIG. 4, in response to a remapping event (e.g., indicated by program data 210, register requests 212, register rules 214, execution statuses 216, or any combination thereof), compiler 204 causes register data 120 to be moved between memory devices. For example, in response to a high priority program 202 that requests more GPRs 116 in memory device 110 than are currently available, compiler 204 causes some register data from other programs to be moved to memory device 108. As another example, in response to that program finishing execution, thus freeing GPRs 116, compiler 204 causes some register data from other programs to be moved to memory device 110. As a third example, in response to the system entering the power saving mode described above, compiler 204 causes some register data to be moved from memory device 106 to memory device 108, memory device 110, or both.

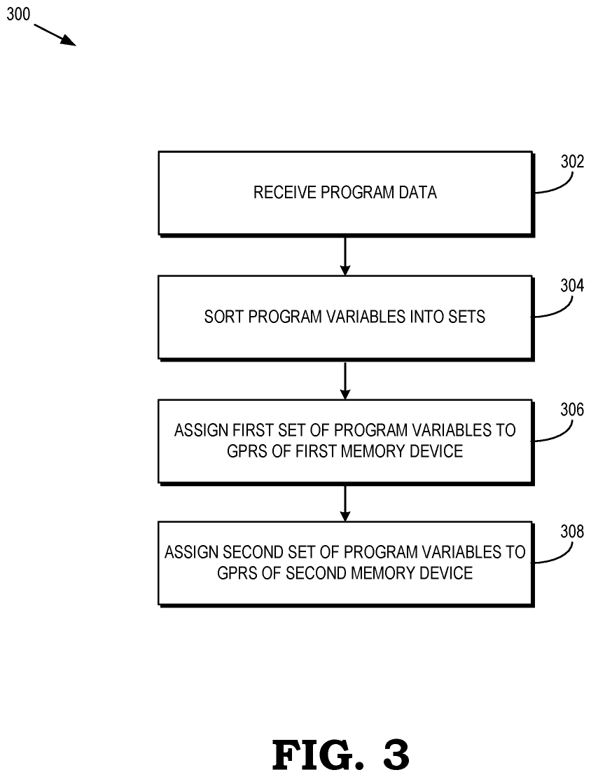

FIGS. 3 and 4 illustrate example GPR allocation processes in accordance with at least some embodiments. As described above, variables are assigned to GPRs to programs based on expected access frequency. FIG. 3 illustrates how a program variables of a received program are assigned to memory devices. FIG. 4 illustrates how program variables are reassigned in response to a remapping event.

FIG. 3 is a flow diagram illustrating a method of allocating GPRs in accordance with some embodiments. In some embodiments, method 300 is initiated by one or more processors in response to one or more instructions stored by a computer readable storage medium. In some embodiments, various portions of method 300 occur in a different order than is illustrated. For example, in some cases, some program variables from the first set are assigned to GPRs in block 306 prior to other program variables being sorted into a set.

At block 302, program data is received. For example, compiler 204 receives program data 210 of a program 202. At block 304, program variables are sorted into sets. For example, program variables of program data 210 are sorted into three sets corresponding to memory device 106, memory device 108, and memory device 110 by generating estimated access frequency indicators for each program variable and comparing the estimated access frequency indicators to access frequency thresholds.

At block 306, a first set of program variables are assigned to GPRs of a first memory device. For example, program variables that have estimated access frequency indicators that exceed all access frequency thresholds are assigned to GPRs of memory device 110. At block 308, a second set of program variables are assigned to GPRs of a second memory device. For example, program variables that have estimated access frequency indicators that do not exceed any access frequency thresholds are assigned to GPRs of memory device 106. Accordingly, a method of allocating GPRs is depicted.

FIG. 4 is a flow diagram illustrating a method of reallocating GPRs in accordance with some embodiments. In some embodiments, method 400 is initiated by one or more processors in response to one or more instructions stored by a computer readable storage medium. In some embodiments, various portions of method 400 occur in a different order than is illustrated or are omitted. For example, in some cases, expected access frequencies are not reevaluated in block 404 and instead the previously generated expected access frequencies are used.

At block 402, an indication of a remapping event is received. For example, compiler 204 receives an indication of a program requesting more GPRs 116 in memory device 110 than are unallocated. As another example, compiler 204 receives an indication of a program terminating, deallocating GPRs 116 in memory device 110. At block 404, expected access frequencies of program variables are reevaluated. At block 406, program variables are reassigned between memory banks. For example, if a program had four program variables that met the criteria to be allocated in memory device 110 but only three GPRs 116 were available, in some cases, the fourth program variable is allocated in a GPR 114 of memory device 108. If another GPR 116 of memory device 110 is subsequently deallocated, in some cases, the program variable is moved from memory device 108 to memory device 110. Additionally, in some cases, other program variables are also reevaluated. For example, in some embodiments, if a program includes a first loop for a first half of the program and a second loop for a second half of the program, depending on the timing of the remapping event, the loop variable of the first loop is no longer expected to be frequently accessed and thus is moved to a memory device that includes more GPRs. Accordingly, a method of reallocating GPRs is depicted.

FIG. 5 is a block diagram depicting of a computing system 500 that includes a processing unit 100 that includes a GPR hierarchy according to some embodiments. Computing system 500 includes or has access to a system memory 505 or other storage component that is implemented using a non-transitory computer readable medium such as a dynamic random-access memory (DRAM). However, in various embodiments, system memory 505 is implemented using other types of memory including static random-access memory (SRAM), nonvolatile RAM, and the like. Computing system 500 also includes a bus 510 to support communication between entities implemented in computing system 500, such as system memory 505. Some embodiments of computing system 500 include other buses, bridges, switches, routers, and the like, which are not shown in FIG. 5 in the interest of clarity.

Computing system 500 includes processing system 540 which includes processing unit 100. In some embodiments, processing system 540 is a GPU that is renders images for presentation on a display 530. For example, in some cases, the processing system 540 renders objects to produce values of pixels that are provided to display 530, which uses the pixel values to display an image that represents the rendered objects. In some embodiments, processing system 540 is a general purpose processor (e.g., a CPU) or a GPU used for general purpose computing. In the illustrated embodiment, processing system 540 performs a large number of arithmetic operations in parallel using processing unit 100. For example, in some embodiments, processing system 540 is a GPU and processing unit 100 is a shader processing unit for processing aspects of an image, such as color, movement, lighting, and position of objects in an image. As discussed above, processing unit 100 includes a hierarchy of memory devices that include differing amounts of GPRs and processing unit 100 allocates program variables to the memory devices based on expected access frequencies. Although the illustrated embodiment illustrates processing unit 100 as being fully included in processing system 540, in other embodiments, processing unit 100 includes fewer, additional, or different components, such as compiler 204, that are also located in processing system 540 or elsewhere in computing system 500 (e.g., in CPU 515). In some embodiments, processing unit 100 is included elsewhere, such as being separately connected to bus 510 or within CPU 515. In the illustrated embodiment, processing system 540 communicates with system memory 505 over the bus 510. However, some embodiments of processing system 540 communicate with system memory 505 over a direct connection or via other buses, bridges, switches, routers, and the like. In some embodiments, processing system 540 executes instructions stored in system memory 505 and processing system 540 stores information in system memory 505 such as the results of the executed instructions. For example, system memory 505 stores a copy 520 of instructions from a program code that is to be executed by processing system 540.

Computing system 500 also includes a central processing unit (CPU) 515 configured to execute instructions concurrently or in parallel. The CPU 515 is connected to the bus 510 and, in some cases, communicates with processing system 540 and system memory 505 via bus 510. In some embodiments, CPU 515 executes instructions such as program code 545 stored in system memory 505 and CPU 515 stores information in system memory 505 such as the results of the executed instructions. In some cases, CPU 515 initiates graphics processing by issuing draw calls to processing system 540.

An input/output (I/O) engine 525 handles input or output operations associated with display 530, as well as other elements of computing system 500 such as keyboards, mice, printers, external disks, and the like. I/O engine 525 is coupled to bus 510 so that I/O engine 525 is able to communicate with system memory 505, processing system 540, or CPU 515. In the illustrated embodiment, I/O engine 525 is configured to read information stored on an external storage component 535, which is implemented using a non-transitory computer readable medium such as a compact disk (CD), a digital video disc (DVD), and the like. In some cases, I/O engine 525 writes information to external storage component 535, such as the results of processing by processing system 540, processing unit 100, or CPU 515.

In some embodiments, a computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. In some embodiments, the computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. In some embodiments, the executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device are not required, and that, in some cases, one or more further activities are performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that cause any benefit, advantage, or solution to occur or become more pronounced are not to be construed as a critical, required, or essential feature of any or all the claims. Moreover, the particular embodiments disclosed above are illustrative only, as the disclosed subject matter could be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above could be altered or modified and all such variations are considered within the scope of the disclosed subject matter. Accordingly, the protection sought herein is as set forth in the claims below.

Within this disclosure, in some cases, different entities (which are variously referred to as “components,” “units,” “devices,” etc.) are described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

What is claimed is:

1. A system comprising:
a first memory device comprising a first plurality of general purpose registers (GPRs);
a second memory device comprising a second plurality of GPRs, wherein the second memory device has fewer GPRs than the first memory device; and
a controller circuit configured to store data at the first plurality of GPRs, the second plurality of GPRs, or both based on an expected frequency of access associated with the data.

2. The system of claim 1, wherein:
the controller circuit is configured to receive the expected frequency of access associated with the data from a compiler that analyzes one or more programs that are to store data using the first memory device, the second memory device, or both.

3. The system of claim 1, wherein:
accessing one of the first plurality of GPRs consumes more power on average than accessing one of the second plurality of GPRs.

4. The system of claim 1, wherein:
the controller circuit is further configured to store at least a portion of the data at the second plurality of GPRs based on GPR requests from programs that request allocation of GPRs of the second plurality of GPRs.

5. The system of claim 1, wherein:
the controller circuit is further configured to store the data at the first plurality of GPRs, the second plurality of GPRs, or both based on register rules.

6. The system of claim 5, wherein:
the register rules comprise a global rule that no more than a specified number of the second plurality of GPRs be assigned to any one program.

7. The system of claim 5, wherein:
the register rules comprise a program-specific rule that no more than a specified number of the second plurality of GPRs be assigned to a program indicated by the program-specific rule.

8. The system of claim 1, further comprising:
a third memory device comprising a third plurality of GPRs, wherein the third memory device has fewer GPRs than the second memory device.

9. A method comprising:
receiving, at a compiler, program data of a program to be executed;
sorting variables of the program into a first set of variables and a second set of variables, wherein the second set of variables are expected to be more frequently accessed by the program than the first set of variables;
indicating that the first set of variables are to be assigned to a first plurality of general purpose registers (GPRs) of a first memory device; and
indicating that the second set of variables are to be assigned to a second plurality of GPRs of a second memory device, wherein accessing one of the first plurality of GPRs consumes more power on average than accessing one of the second plurality of GPRs.

10. The method of claim 9, wherein:
sorting the variables of the program is based on a number of unassigned GPRs of the second plurality of GPRs.

11. The method of claim 9, wherein:
sorting the variables of the program is based on comparing the respective expected frequency of accesses of the variables to an access frequency threshold.

12. The method of claim 11, further comprising:
adjusting the access frequency threshold based on a number of unassigned GPRs of the second plurality of GPRs.

13. The method of claim 9, further comprising:
remapping at least one variable between the first plurality of GPRs and the second plurality of GPRs in response to a remapping event.

14. The method of claim 13, wherein:
the remapping event comprises an indication of overallocation of GPRs of the second plurality of GPRs or an indication of deallocation of GPRs of the second plurality of GPRs.

15. The method of claim 9, wherein:
the program indicates a requested number of the second plurality of GPRs to be assigned, and wherein sorting the variables of the program is based on the requested number.

16. A shader processing unit comprising:
a first memory device comprising a first plurality of general purpose registers (GPRs);
a second memory device comprising a second plurality of GPRs, wherein accessing one of the first plurality of GPRs consumes more power on average than accessing one of the second plurality of GPRs; and
a plurality of shader engines configured to execute programs using data stored at the first memory device, the second memory device, or both.

17. The shader processing unit of claim 16, further comprising:
a shader controller to move data between a system memory and the first plurality of GPRs, the second plurality of GPRs, or both based on an expected frequency of access associated with the data.

18. The shader processing unit of claim 17, wherein:
the shader controller is further to move data between the first and second memory devices and the plurality of shader engines.

19. The shader processing unit of claim 18, wherein:
the shader controller is to move data from the first memory device to a first shader engine concurrently with moving data from the second memory device to a second shader engine.

20. The shader processing unit of claim 17, further comprising:
a shader compiler to:
compile one or more programs that use data to be stored at the first memory device, the second memory device, or both;
determine the expected frequency of access associated with the program data based on a weighting process; and
assign GPRs of the first plurality of GPRs, the second plurality of GPRs, or both to the one or more programs based on the expected frequency of access.
